(19) United States
(12) Patent Application Publication
(10) Pub. No.: US 2021/0127911 A1
(43) Pub. Date: May 6, 2021

(54) Device for storing and/or removing cloths and method of manufacturing a device for storing and/or removing cloths

(71) Applicant: imeco GmbH & Co. KG, Hösbach (DE)

(72) Inventors: Bernhard AWOLIN, Hösbach (DE); Friederike SZIEGAT, Hösbach (DE); Dietmar DOMSCH, Bonn (DE)

(21) Appl. No.: 16/639,415

(22) PCT Filed: Aug. 16, 2018
(86) PCT No.: PCT/DE2018/000239

§ 371 Date: Feb. 14, 2020

(30) Foreign Application Priority Data
Aug. 18, 2017 (DE) 10 2017 007 754.1

(51) Int. Cl. A47K 10/38; G01G 19/52; G06K 7/10; G06Q 10/08

(52) U.S. Cl. CPC A47K 10/38; G01G 19/52; A47K 2010/3266; G06Q 10/087; G06K 7/10297

(57) ABSTRACT

Device for storing and/or removing wipes comprises a supply region, a preferably solid-walled vessel, and in particular a covering region on an upper side which cannot be removed without leaving a residue. The covering region has a removal opening through which the wipes can be removed and which can be covered by a closure means. The removal opening particularly has a diameter which is designed to be adapted to a diameter of the supply package in such a way that the supply package as a whole is prevented from being guided through the removal opening. A docking station is provided, wherein the supply region can be connected to a sensor means and/or receiving means of the docking station via an interface means by means of signal exchange. The docking station is designed to be particularly adapted for docking for the supply region.

### TECHNICAL FIELD

The invention concerns a device for storing and/or removing cloths, in particular disposable cloths and to a method for manufacturing a device for storing and/or removing cloths.

### BACKGROUND

It is known that cloth stations with cloth supply, especially cloth rolls with disinfection function, are improperly handled, especially improperly refilled or have an excessively long service life and can therefore become a safety risk for patients or the environment to be cleaned. In particular, the filling with disinfectants that can be mixed by the user, the effectiveness of the wipe/liquid combination, as well as a container that is difficult to close/open and the removal of the soaked wipes, which may not be completely sterile, have been viewed particularly critically in recent years. In the worst case, this can lead to an unsafe product and thus to a disinfection that does not comply with the regulations in hospitals, old people's and nursing homes, as well as in general medical practices where routine disinfection is mandatory. The consequence is an increased risk of contamination, for example MRSA, and thus an increased risk of nosocomial infections.

### SUMMARY

The purpose of the present invention is to provide a simple and safe device for storing and/or removing cloths, in particular disposable cloths, which avoids the disadvantages mentioned.

The task is solved by a device for storing and/or removing wipes, in particular disposable wipes, in particular wet wipes with a working fluid, in particular for cleaning and/or disinfection, comprising a storage area, in particular with an internally inserted storage container for wipes, in particular a wipe roll, a preferably fixed-walled container, and in particular a covering area on an upper side which cannot be removed without residue, which has a removal opening through which the wipes can be removed and which can be covered by a closure means, wherein the removal opening has in particular a diameter which is adapted to a diameter of the storage container in such a way that a passage of the storage container as a whole through the removal opening is prevented, wherein a docking station is provided, wherein the storage area can be connected via an interface means by means of signal exchange, in particular for connection and/or recognition and/or activation, to a sensor and/or receiving means of the docking station, wherein the docking station is in particular adapted for docking for the storage area.

The invention enables a safe and monitorable refillable wipe station, in particular a disinfection station and its disposable refill systems, which can be operated by means of electronic/magnetic data transfer, in particular RFID, NFC, Bluetooth and further with corresponding data receivers as connection station, in particular also computers, mobile phones etc., to be replenished with a refillable wipe station. and thus ensure that the application is as risk-free as possible, in particular the provision of operating instructions, information on the product, as well as a reordering service, etc. The technology is advantageously based on RFID or NFC, which are inserted via an interface (chip/tag) for data transfer, both in the station and in the refilling system. The invention enables the following safe use, in particular safety in use by LED indicator, click-in enables activation, level indicator checks product weight and thus sufficient amount of liquid etc., Manipulations, e. g. B. Dilution/refill, are excluded, reordering can be triggered automatically, system can be connected via battery/mains/ USB, product data can be retrieved, especially batch traceability etc., also an easy application through updatable instructions for use z. B. on display, a check of the 28-day best-before date of use for surface disinfection products. Several stations could be networked with a “master” station.

It is advantageous if the sensor and/or receiver means comprises an RFID and/or NFC means and/or Bluetooth, which is incorporated in the docking station, in particular computer and/or smartphone, and/or in the storage area, which in particular has a sensor and/or receiver means.

It is advantageous if the sensor and/or receiver means of the docking station and/or the cloth storage area of several docking stations are networked via a master station.

It is advantageous if the sensor and/or receiver means, in particular the docking station, includes an integrated weight measuring device by which the weight and/or the weight difference of the storage area can be registered.

It is advantageous if the sensor and/or receiver means of the docking station and/or the storage area can determine the consumption of wipes, in particular by measuring the weight of the storage area, thus in particular the product weight of the wipes and/or the quantity of the working fluid, in particular by means of an integrated scale, whereby a reordering process must be activated, if pre-soaked cloths are predominantly used up, in particular used up to more than about 50%, in particular up to about 80%, whereby in particular a check of the best before date for use with surface disinfection products is to be carried out and/or the retrieval of product data, in particular batch tracing, and/or a power/charging cable/USB connection is provided.

It is advantageous if the sensor and/or receiver means can be activated by clicking into the storage area and/or into the docking station, whereby in particular the docking station and/or the storage area has an adapted contour.

It is advantageous if a signaling means, in particular an LED lamp, in particular for filling level and/or system readiness and/or error messages is provided, in particular as a filling level indicator for consumption, in particular as a signaling means of the balance, in particular in the docking station, in particular a display, in particular also for the presentation of an operating video, in particular including a touch display, in particular with sound transmission.

It is advantageous if the covering area has a covering means, in particular a film-like covering means, which is adapted to the vessel, in particular a stable and/or liquid-tight and/or germ- tight lid and/or composite film, for example comprising PET/PE and/or PET/PP and/or PE and/or PP and/or PET/aluminium/PE or other fixable film materials and/or the removal opening has a connecting area, in particular a thread, and comprises a counterpart, in particular a locknut, which has a right-hand thread and/or a left-hand thread, the counterpart being firmly inserted, in particular welded, in the film-like covering means, in particular centrally, the counterpart being sealed in the covering region, in particular in the film-like covering means, in such a way that it is sealed, with a sealing means which cannot be removed without residue, in particular in the form of a ring or directly with the covering region, that no residue-free removal of the counterpart from the covering region and/or of the covering region from the vessel is possible, wherein the removal opening is formed substantially round and/or a covering means, in particular a label and/or a removable closure film is attached to the removal opening, in particular stretched over the connecting region and/or the connecting region can be clipped and/or screwed in and/or is formed with a bayonet closure and/or a sliding closure, wherein a removal means can be inserted into the removal opening through which the wipes can be removed, wherein the removal means has a substantially closed opening surface with a central, cross-like lead-through region which, in relation to the opening surface, comprises in particular less than about a quarter of the diameter of the opening surface, in particular less than a fifth.

It is advantageous if the vessel of the storage area is filled with a working liquid in addition to the storage container and/or is to be filled subsequently after the insertion of a storage container, in particular with a cleaning liquid and/or cosmetic liquid and/or disinfecting liquid, in particular comprising water, ethanol, isopropanol, quaternary ammonium salts, biguanides, organic fruit acids, silver ions, copper compounds and any suitable mixtures and auxiliary materials.

It is advantageous if the cloth has a non-woven fabric, in particular a non-woven cloth designed as a washing glove impregnated with a working fluid, the non-woven fabric having in particular a thermal hot air and/or other types of bonding, for example chemically bonded or hydro-jet bonded nonwoven, in particular comprising polyester and mixtures with PP/CV and/or PET/PE and/or PE/PP and/or PET/Co-PET bicomponents, and/or pure PP and/or that the cloths are impregnated with a disinfecting liquid. comprising continuous fibres and/or staple fibres comprising cellulose, in particular viscose and/or Tencel and/or cotton and/or PP and/or PE and/or PES and/or bicofibres, in particular a combination comprising PP and PE, PP/PES, PES and CoPES, and/or PLA and/or PLA Bico or mixtures of the said fibres in particular produced by manufacturing process as spunbonded and/or non-woven fabric comprising staple fibres, in particular thermo-bonded and/or needle-bonded and/or hydro-jet-bonded and/or hot-air-bonded and/or binder-bonded and/or the cloth is provided with a sensor and/or receiving means.

The task is also solved by a process for the manufacture of a device for storing and/or removing wipes, in particular disposable wipes, in particular wet wipes, in particular according to one of the claims 1 to 9, in particular wet wipes with a working liquid, in particular for cleaning and/or disinfection, comprising a storage area, in particular with an internally inserted storage container for cloths, in particular a cloth roll, a preferably fixed-walled container, and in particular a cover area on an upper side which cannot be removed without residue, which has a removal opening through which the cloths are removed, and which is covered by a closure means, wherein the removal opening has in particular a diameter which is adapted to a diameter of the storage container in such a way that a passage of the storage container as a whole through the removal opening is prevented, wherein an appropriately designed docking station is docked to the storage area, wherein a docking station is provided, wherein the storage area is connected via an interface means by means of signal exchange to a sensor and/or receiving means of the docking station, wherein the docking station is designed in particular to be adapted for docking for the storage area.

An advantageous manufacturing process of a ready-to-use disinfection station may include fitting a disposable refill system into the docking station, the RFID/NFC tag activates the docking station, the user manual may appear on the display, if necessary. with sound, batch and other production data can be called up, the refill system can be weighed by the integrated scale, the fill level is displayed, the system readiness is indicated by LED or e.g. “ok”; appears in the display, the lid can be opened and wipes can be removed for disinfection etc. If pre- soaked cloths are too z. B. 80% are consumed, especially by measuring with the scale, the reordering can be activated. Through WLAN networking, repeat orders can be placed automatically. The empty system can be removed from the station and disposed of directly in the household waste. A new refill system can be inserted and reactivated.

### BRIEF DESCRIPTION OF THE DRAWINGS

Further features and advantages of the invention result from the claims and the description below, in which examples of the execution of the subject of the invention in connection with the drawings are explained in more detail.

FIG. 1 shows a device for storing and/or removing wipes in perspective view.

### DETAILED DESCRIPTION

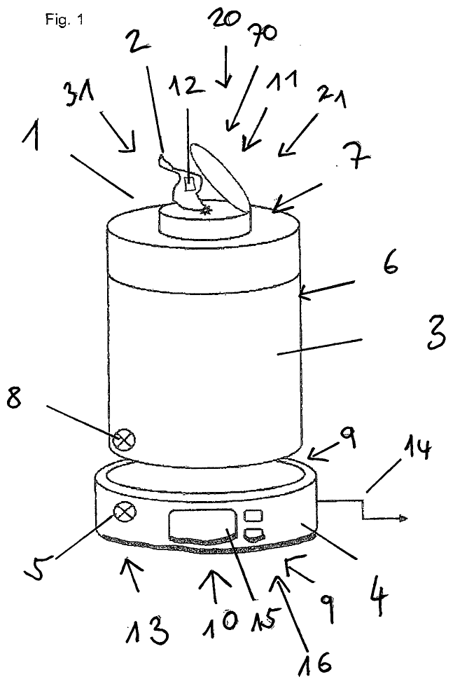

FIG. 1 shows a device 1 for storing and/or removing wipes 2, in particular disposable wipes, in particular wet wipes with a working fluid, in particular for cleaning and/or disinfection, in particular a disinfection station with refill system, in particular as a disposable product with pre-soaked disinfection wipes in the container, comprising a storage area 3, in particular with an internally inserted storage container for cloths, in particular a cloth roll, a preferably fixed-walled vessel 6, and in particular a covering area on an upper side 21 which cannot be removed without residue, which has a removal opening 11 through which the cloths 2 can be removed, and which can be covered by a closure means 70 wherein the removal opening 11 has in particular a diameter which is adapted to a diameter of the storage container in such a way that a passage of the storage container as a whole through the removal opening 11 is prevented, wherein a docking station 4 is provided, wherein the storage area 3 is connected to the supply container via an interface means 13 by means of signal exchange with a sensor and/or receiving means 8, NFC/RFID tags for data transfer, in particular for connecting, recognising, activating the docking station 4, wherein the docking station is designed in particular adapted for docking for the supply area 3 with an optional power/charging cable/USB connection 14 and a suitable contour for the refilling system, with a display 15, an optional touch display, for example including sound transmission, if necessary for operation video, e. g. operating elements 16 and/or LED lamps for level indicators and/or for system readiness or error messages, as well as an integrated weight measuring device 9.

An additional interface can be advantageously located on the cloth 2 by means of an RFID or other transmitter/receiver, sensor and/or receiving means, so that, for example, the appropriate system requirements can be easily met.

The bucket/container has an advantageous volume of about 1-7 litres, preferably with a filling volume of about 2-5 litres. The shape can be round or square with optional rounded corners, in particular conically tapering downwards, so that they can be stacked. The lid/bucket/container system can be sealed liquid-tight, for example, by pressing on and/or ultrasonic welding, and can only be opened again by means of a safety lock which prevents the system from being closed several times, so that the buckets/containers can be stacked one inside the other for disposal.

The covering area 7 can have a film-like covering means adapted to the vessel 6, in particular a stable and/or liquid-tight and/or germ-proof composite film, for example comprising PET/PE and/or PET/PP and/or PE and/or PP and/or PET/aluminium/PE or other fixable film materials and/or the removal opening 11 a connecting area 31, in particular a thread, and comprises a counterpart, in particular a locknut, which has a right-hand thread and/or a left-hand thread, the counterpart being firmly inserted, in particular welded, in the film-like covering means, in particular centrally, the counterpart is sealed in the covering area 7, in particular in the film- like covering means, with a sealing means which cannot be removed without residue, in particular in the form of a ring or directly with the covering area, in such a way that no residue- free removal of the counterpart from the covering area and/or of the covering area 7 from the vessel 6 is possible, wherein the removal opening 11 is substantially round in shape and/or a covering means 20, in particular a label and/or a removable sealing film is attached to the removal opening 11, in particular stretched over the connecting region 31 and/or the connecting region 31 can be clipped and/or screwed in.

### LIST OF REFERENCE SIGNS

1 device for storing and/or removing cloths 2 cloth

3 storage area

4 docking station

5 sensor and/or receiving means

6 vessel

7 coverage area

8 sensor and/or receiving means

9 weight measuring device

10 signal means

11 removal opening

12 sensor and/or receiver means of the cloth

13 interface means

14 connection

15 display

16 control element

20 sealing agent

21 top side

31 connection area

70 sealing agent

1.-11. (canceled)

12. A device for storing and/or removing wipes (2), comprising:
a storage area (3);
a fixed-walled container (6);
a storage container for the wipes (2) arranged within the fixed-wall container (6);
a covering area on an upper side (21) which cannot be removed without residue, the covering area having a removal opening (11) through which the wipes (2) can be removed and a closure (70) which can cover the removal opening (11),
wherein the removal opening (11) has a diameter which is adapted to a diameter of the storage container in such a way that a passage of the storage container as a whole through the removal opening (11) is prevented; and
a docking station (4) for docking to the storage area (3),
wherein the storage area (3) can be connected via an interface (13) by signal exchange to a sensor and/or receiving means (5) of the docking station (4).

13. The device according to claim 12,
wherein the wipes (2) are selected from the group consisting of disposable wipes, wet wipes with a working fluid, and wipes for cleaning and/or disinfecting, and
wherein the storage container for the wipes is a cloth roll.

14. The device according to claim 12,
wherein the sensor and/or receiving means (5) comprises an RFID and/or NFC means and/or Bluetooth.

15. The device according to claim 14,
wherein the sensor and/or receiving means (5) of several docking stations (4) are networked via a master station.

16. The device according to claim 12,
wherein the sensor and/or receiver means (5) is arranged in the docking station (4) and comprises an integrated weight measuring device (9) by means of which a weight and/or a difference in weight of the storage area (3) can be registered.

17. The device according to claim 12,
wherein a consumption of the wipes (2) can be determined by the sensor and/or receiver means (5) of the docking station (4) by measuring a weight of the storage area (3),
wherein a reorder is to be activated if the wipes (2) are predominantly used up,
wherein a check of a best before date for use with surface disinfection products is to be carried out and/or a retrieval of product data, and/or
wherein a power/charging cable/USB connection is provided.

18. The device according to claim 12,
wherein activation of the sensor and/or receiver means (5, 8) is effected by clicking the storage area (3) into the docking station (4), and
wherein the docking station (4) and the storage area (3) have an adapted contours.

19. The device according to claim 12, further comprising
a signal means (10) selected from the group consisting of an LED lamp, a display, and a touch display with sound transmission,
wherein the signals means (10) is configured as one or more of a filling level indicator, a system readiness indicator, an error message indicator, a consumption indicator, a balance indicator, and a presentation of an operating video, and
wherein the signals means (10) is arranged in the docking station (4).
